(19) United States
(12) Patent Application Publication
(10) Pub. No.: US 2023/0331570 A1
(43) Pub. Date: Oct. 19, 2023

(54) Method for the Manufacture of Lithium Metal Oxides and Phosphates

(71) Applicant: Sylvatex, Inc., ALAMEDA, CA (US)

(72) Inventors: Yi-Ting Chen, Fremont, CA (US); Yanying Lu, Fremont, CA (US); Valeria Miramontes, Half Moon Bay, CA (US); Edward Stafford, Mountain View, CA (US); Daniel Teav Sun, San Francisco, CA (US); Ahmad Dehestani, Walnut Creek, CA (US); Melvin Louis Luetkens, JR., Batavia, IL (US)

(73) Assignee: Sylvatex, Tucson, AZ (US)

(21) Appl. No.: 18/300,365

(22) Filed: Apr. 13, 2023

Related U.S. Application Data
(60) Provisional application No. 63/330,636, filed on Apr. 13, 2022.

(51) Int. Cl. C01D 15/00

(52) U.S. Cl. CPC C01D 15/00

(57) ABSTRACT

A method of producing a particulate lithium metal oxide or lithium metal phosphate material comprising the steps of providing one or more metal compounds, adding sufficient water to dissolve the one or more metal compounds to form a metal compound solution, adding a first basic solution, a second basic solution and the metal compound solution at predetermined rates to a reaction vessel containing water to form a reaction mixture, heating the reaction mixture while maintaining a pH of the reaction mixture in a predetermined pH range, adding a lithium compound, adding a fatty acid, filtering a precipitate, washing and preferably drying the precipitate, calcining the dried precipitate in an atmosphere containing oxygen to form a calcined lithium metal oxide or lithium metal phosphate, cooling and sizing the calcined lithium metal oxide or lithium metal phosphate to produce a particulate lithium metal oxide or lithium metal phosphate material having a predetermined average particle size.

### CROSS-REFERENCE TO RELATED APPLICATIONS

This application claims priority to U.S. Provisional Patent Application No. 63/330,636 titled “Method for the Manufacture of Lithium Metal Oxides” filed on Apr. 13, 2022, the entire disclosure of which is incorporated herein by reference.

### TECHNICAL FIELD

The present disclosure relates to lithium-ion battery cathode materials.

### BACKGROUND

Lithium-ion batteries (LIBs) have emerged as the leading technology to power electric vehicles (EVs). However, the biggest issue with making this transition today is that the demand for lithium-ion batteries far outstrips the ability to supply the market. To hit critical market adoption, the LIB must be safe, low-cost, and feature high-energy-density. Furthermore, the overall impact of battery manufacturing itself needs to have a much lower carbon footprint. It is thus critical to develop low-cost, sustainable manufacturing practices.

According to the findings by the LIFE Institute for Climate, Energy, and Society, the processes to produce cathodes, make up about 45% of the greenhouse gas emissions of the total material production of LIBs. Furthermore, 80% of an EV's total lifetime emissions can come from the embodied energy of fabricating the battery and then charging the battery. Conventional wet processing methods for cathode production typically create large amounts of solvents that need to be disposed of or recycled using energy-intensive collection and distillation systems. For this reason, the cathode production methods have great potential to lower the carbon footprint of EVs.

### SUMMARY

One aspect of the present invention is a method of producing a particulate lithium metal oxide material comprising the steps of providing a metal compound, adding sufficient water to dissolve the metal compound and form a metal compound solution, adding a first basic solution, a second basic solution and the metal compound solution to a reaction vessel containing water to form a reaction mixture, heating the reaction mixture while maintaining a pH of the reaction mixture in a predetermined pH range, adding a lithium compound, adding a fatty acid, filtering a precipitate, washing and drying the precipitate calcining the dried precipitate in an atmosphere containing oxygen to form a calcined lithium metal oxide, cooling the calcined lithium metal oxide, and sizing the calcined lithium metal oxide to produce a particulate lithium metal oxide having a predetermined average particle size.

In another aspect of the invention, the first basic solution, second basic solution, and the metal compound solution are added simultaneously to the reaction vessel containing water.

In a still further aspect, the basic solutions, the metal compound solution, the lithium compound, and the fatty acids are added simultaneously to the reaction vessel.

In a yet still further aspect, the fatty acids are filtered before being added to the reaction vessel to remove solid contaminants or crystallized fatty acids.

In another aspect, an optional anti-foaming agent is added to one of the basic solutions prior to addition to the reaction vessel.

In another aspect of the invention, the reaction mixture is agitated to improve mixing of the components of the reaction mixture.

In still another aspect, after filtering the precipitate a filtrate is formed and where the filtrate is recycled and re-used to form additional precipitate.

In a still further aspect, the particulate lithium metal oxide is suitable for use in a cathode in a lithium-ion battery.

In a still yet further aspect, the method of producing a particulate lithium metal oxide material further comprises the step of sizing the dried precipitate before calcining.

In another still yet further aspect, heat is continuously applied to the reaction mixture.

In another aspect of the invention, the lithium metal oxide comprises a composition of LiMₓO_{y}. The M is manganese (Mn), nickel (Ni), or cobalt (Co). The M is selected from the group consisting of aluminum (Al), titanium (Ti), iron (Fe), vanadium (V), magnesium (Mg), zirconium (Zr), tungsten (W), tantalum (Ta), and boron (B). The x is 1 or 2 and wherein y is 2 or 4

In still another aspect, the lithium compound or the metal compound comprises an anionic component that is selected from the group consisting of hydroxide, carbonate, acetate, alkoxide, oxalate, nitrate, nitride, sulfate, and oxide.

In a still further aspect, the method of producing a particulate lithium metal oxide material further comprises the step of forming an outer layer on the lithium metal oxide particles. The outer layer comprises Li and Co-rich material. Forming the outer layer of Li and Co-rich material on the comminuted lithium metal oxide cathode comprises the steps of tumbling the lithium metal oxide with Li and Co-containing precursor materials to form a coated lithium metal oxide and calcining the coated lithium metal oxide to form a lithium metal oxide with a Li and Co-rich layer such that the Co does not substantially enter the structure of the lithium metal oxide portion.

In a yet still further aspect, calcining the dried precipitate comprises the following steps of first placing the precipitate in a calciner, then heating the precipitate to 300-400° C. at a ramp rate of up to 15° C./min and holding at 300-400° C. for two to four hours, then heating the precipitate to 500-600° C. at a ramp rate of up to 15° C./min and holding for two to four hours, and then heating the precipitate to 700-900° C. at a ramp rate of up to 4° C./min and holding for four to seven hours. Calcining further comprises an initial low temperature calcining step wherein the dried precipitate is heated to about 150-250° C. at a ramp rate of about 0.1 to about 15° C./min and holding for about 0.5 to 10 hours.

In another aspect of the invention, further comprising adding a dopant to the reaction mixture. The dopant replaces a portion of the metal component in the lithium metal oxide. The dopant is selected from the group consisting of W, Ti, Mo, Mg, V, Zr, Zn, Nb, Cr, In, Au, B, Fe, Ta, and Ru.

In still another aspect, the particulate lithium metal oxide comprises a coating of an electrically conductive carbon.

In a still further aspect, the particulate lithium metal oxide is substantially monocrystalline or polycrystalline.

In a yet still further aspect, the calcined lithium metal oxide has a layered or spinel structure.

In another still yet further aspect, the metal compound is provided from a recycled cathode, recycled metal oxide, or recycled metal hydroxide.

In another aspect, the first or second basic solution can be the same or different and comprises potassium hydroxide, sodium hydroxide, sodium carbonate, potassium carbonate, ammonium carbonate, or ammonium hydroxide.

In still another aspect, a method of producing a particulate lithium mixed metal oxide material having a formula of Li(M1)ₓ(M2)₁₋ₓO₂, the method comprising providing a first metal compound (M1)A1ₓ and a second metal compound (M2)A2_{y} where x is 1 or 2 and y is 1 or 2, dissolving the first and second metal compounds in water to form an aqueous metal compound solution, adding a first basic solution, a second basic solution and the aqueous metal compound solution at predetermined rates to a reaction vessel containing water to form a reaction mixture, heating the reaction mixture while maintaining a pH of the reaction mixture in a predetermined pH range, adding a lithium compound, adding a fatty acid, filtering a precipitate, washing and drying the precipitate, calcining the precipitate in a gas comprising oxygen to yield a calcined lithium mixed metal oxide, cooling the calcined lithium mixed metal oxide, and sizing the calcined lithium mixed metal oxide to produce a particulate lithium mixed metal oxide having a predetermined average particle size.

In a still further aspect, the first basic solution, second basic solution, and the metal compound solution are added simultaneously to the reaction vessel containing water.

In a yet still further aspect, the basic solutions, the metal compound solution, the lithium compound, and the fatty acids are added simultaneously to the reaction vessel.

In another aspect of the invention, a fluoride-based compound is added to the reaction vessel such that a portion of the oxygen atoms in the oxide layer in the Li(M1)ₓ(M2)₁₋ₓO₂ structure are replaced by fluorine atoms.

In still another aspect, the fatty acids are filtered before being added to the reaction vessel to remove solid contaminants or crystallized fatty acids.

In a still further aspect, a de-foaming agent is added to one of the basic solutions prior to addition to the reaction vessel.

In a yet still further aspect, the particulate lithium mixed metal oxide material having a formula of Li(M1)ₓ(M2)₁₋ₓO₂, where M1 and M2 are different and independently selected from the group consisting of nickel (Ni), cobalt (Co), manganese (Mn), and aluminum (Al). M1 and M2 are different and independently selected from the group consisting of titanium (Ti), iron (Fe), vanadium (V), magnesium (Mg), zirconium (Zr), tungsten (W), tantalum (Ta), and boron (B).

In another still yet further aspect, A1 and A2 are anionic components independently selected from the group consisting of hydroxide, carbonate, acetate, alkoxide, phosphate, oxalate, nitrate, nitride, sulfate, and oxide.

In another aspect of the invention, further comprising adding a third metal compound (M3)A3_{z}, where z is 1 or 2 and M3 is a different metal than M1 or M2, to the aqueous metal compound solution to thereby form a lithium mixed metal oxide Li(M1)ₐ(M2)_{b}(M3)_{c}(M4)_{d}O₂ wherein a+b+c=1. M1, M2 and M3 are independently selected from the group consisting of nickel, cobalt, manganese, and aluminum

In a still further aspect, further combining a fourth metal compound (M4)A4_{zz} wherein zz is 1 or 2 and M4 is a different metal than M1, M2 or M3, to the aqueous metal compound solution to form a lithium mixed metal oxide Li(M1)ₐ(M2)_{b}(M3)_{c}(M4)_{d}O₂ wherein a+b+c+d=1. M1, M2, M3, and M4 are independently selected from the group consisting of nickel, cobalt, manganese, and aluminum

In a yet still further aspect, M1, M2, M3, and M4 are independently selected from the group consisting of titanium (Ti), iron (Fe), vanadium (V), magnesium (Mg), zirconium (Zr), tungsten (W), tantalum (Ta), and boron (B).

In another aspect, the first basic solution is added to the reaction vessel at a first rate R, the second basic solution is added at a rate of 0.1-0.3 ×R, and the aqueous metal compound solution is added at a rate of 0.2-1.2 ×R. The first basic solution is added at the first rate R over a period of 15-25 hours.

In another aspect of the invention, the lithium compound is added at a molar ratio of 1-2 ×the combined moles of transition metals in the metal compounds.

In still another aspect, the fatty acid is added at a rate of 2-6 ×R.

In a still further aspect, the fatty acid is added at a molar ratio of 0.1-1 ×moles of lithium.

In a still yet further aspect, after filtering the precipitate a filtrate is formed and where the filtrate is recycled and re-used to form additional precipitate.

In another still yet further aspect, a method of producing a particulate lithium mixed metal oxide material further comprises the step of sizing the dried precipitate before calcining.

In another aspect of the invention, calcining the dried precipitate forms a polycrystalline or monocrystalline lithium mixed metal oxide and comprises the following steps of first placing the precipitate in a calciner, then heating the precipitate to 300-400° C. at a ramp rate of up to 15° C./min and holding at 300-400° C. for two to four hours, then heating the precipitate to 500-600° C. at a ramp rate of up to 15° C./min and holding for two to six hours, and then heating the precipitate to 700-1000° C. at a ramp rate of up to 4° C./min and holding for four to fifteen hours.

In still another aspect, calcining the dried precipitate further comprises an initial low temperature calcining step wherein the dried precipitate is heated to about 150-250° C. at a ramp rate of about 0.1 to about 15° C./min and holding for about 0.5 to 10 hours.

In a still further aspect, a method of producing a particulate lithium metal phosphate material comprising the steps of providing a metal compound, adding sufficient water to dissolve the metal compound and form a metal compound solution, adding a first basic solution and a second basic solution wherein the first or second basic solution comprises a phosphate containing compound to the metal compound solution simultaneously at predetermined rates in a reaction vessel containing heated water to form a reaction mixture, heating the reaction mixture while maintaining a pH of the reaction mixture in a predetermined pH range, adding a lithium compound, adding a fatty acid, filtering a precipitate, washing and drying the precipitate, calcining the dried precipitate in an inert atmosphere to form a calcined lithium metal phosphate, cooling the calcined lithium metal phosphate, and sizing the calcined lithium metal phosphate to produce a particulate lithium metal phosphate having a predetermined particle size.

In a yet still further aspect, the first or second basic solution comprises (NH₄)₃PO₄, Na₃PO₄, Li₃PO₄, K₃PO₄, H(NH₄)₂PO₄, or H₂(NH₄)PO₄.

In another aspect of the invention, the metal is iron (II), nickel (II), manganese (II), cobalt (II), or a combination thereof.

In still another aspect, the lithium compound comprises Li₃PO₄, Li₂HPO₄, or LiH₂PO₄.

Further aspects and embodiments are provided in the following drawings, detailed description, and claims. Unless specified otherwise, the features as described herein are combinable and all such combinations are within the scope of this disclosure.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale. In some instances, certain elements of the drawing may be enlarged with respect to other elements of the drawing for purposes of illustration.

FIG. 1 is a block diagram of a one-pot method to manufacture a particulate lithium metal oxide, according to an embodiment of the disclosure.

FIG. 2 is a block diagram of a one-pot method to manufacture a particulate lithium mixed metal oxide, according to an embodiment of the disclosure.

FIG. 3 is a schematic diagram illustrating a continuous manufacturing process for lithium metal and mixed metal oxides, according to an embodiment of the disclosure.

FIG. 4 is a block diagram of a one-pot method 300 to manufacture a particulate lithium metal phosphate, according to an embodiment of the disclosure.

FIG. 5 is the x-ray diffraction pattern for LiNi_{0.6}Mn_{0.2}Co_{0.2}O₂ synthesized from metal acetate precursors.

FIG. 6 is an SEM image of LiNi_{0.6}Mn_{0.2}Co_{0.2}O₂ particles synthesized from metal acetate precursors.

FIG. 7 is the x-ray diffraction pattern for LiNi_{0.6}Mn_{0.2}Co_{0.2}O₂ synthesized from metal sulfate precursors.

FIG. 8 is an SEM image of LiNi_{0.6}Mn_{0.2}Co_{0.2}O₂ particles synthesized from metal sulfate precursors.

FIG. 9 is cycle life data for LiNi_{0.6}Mn_{0.2}Co_{0.2}O₂ synthesized from metal sulfate precursors.

FIG. 10 is an SEM image of LiNi_{0.6}Mn_{0.2}Co_{0.2}O₂ 250 particles synthesized from metal sulfate precursors with a low temperature heating step.

FIG. 11 is x-ray diffraction data showing the effect of higher final calcination temperatures on the crystallinity of LiNi_{0.6}Mn_{0.2}Co_{0.2}O₂.

FIG. 12 is a close up of the region at 45 degrees showing the effect of higher final calcination temperatures on the crystallinity of LiNi_{0.6}Mn_{0.2}Co_{0.2}O₂.

FIG. 13 is a plot of final calcination temperature versus tap density of LiNi_{0.6}Mn_{0.2}Co_{0.2}O₂.

FIG. 14 is a plot of final calcination temperature versus % Ni/Li ion exchange of LiNi_{0.6}Mn_{0.2}Co_{0.2}O₂.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

Overview

Certain embodiments of methods and compositions described herein are directed towards a one-pot method for the manufacture of cathode materials for LIBs. The one-pot method includes adding a first and second basic solution along with a solution containing one or more metal compounds to a reaction vessel with heated water that is maintained within a pH range. A lithium compound solution and a fatty acid is then added to the reaction vessel. A precipitate is filtered and dried and then calcined to form a lithium metal oxide or lithium mixed metal oxide.

The manufacturing method may further include adding a dopant to the metal compound solution to form a doped lithium metal or mixed metal oxide. The lithium metal or mixed metal oxide may also be coated.

Other embodiments of methods described herein are directed towards a continuous process for the manufacture of cathode materials. The continuous process method includes adding a metal compound solution, one or more basic solutions, a Li compound solution and one or more fatty acids simultaneously to a reactor. A precipitate is filtered and calcined and the filtrate may be recycled and reused by adding to the reactor for further production of a precipitate for calcination.

Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, the term “lithium-ion battery,” sometimes abbreviated as “LIB,” is meant to refer to a type of rechargeable battery in which lithium ions move from the negative electrode through an electrolyte to the positive electrode during discharge, and back when charging. Li-ion batteries use an intercalated lithium compound as the material at the positive electrode and typically graphite at the negative electrode.

As used herein, the term “cathode” or “cathode material” is meant to refer to the particulate material that is used to form the cathode electrode that is, in turn, used to assemble a Li ion battery or other polarized electrical device. The cathode material is typically added to a solvent, conductive additive, adhesive, or other materials that are then mixed and coated onto a current collector to form the cathode electrode. The cathode electrode is that from which a conventional current leaves in a polarized electrical device, such as a LIB. A conventional current describes the direction in which positive charges move. Electrons have a negative electrical charge, so the movement of electrons is opposite to that of the conventional current flow.

As used herein, the term “comminution” is meant to refer to the reduction of solid materials from one average particle size to a smaller average particle size, by crushing, grinding, cutting, vibrating, milling or other processes. Impact, shear, and compression forces are typically used to affect the comminution of particles.

As used herein, the term “dopant” or “doping agent” is meant to refer to a trace or small amount of impurity element that is introduced into a chemical material to alter its original electrical or optical properties. The amount of dopant necessary to cause changes is typically very low. The amount of dopant may be in the range of about 0.001-5% by mole or about 0.001-1% by mass. When doped into crystalline substances, the dopant's atoms get incorporated into its crystal lattice.

As used herein, the term “spinel” is meant to refer to a class of materials with a spinel crystal structure with the general formula AB₂X₄ where A is an alkali cation and B is a metal cation which crystallize in the cubic (isometric) crystal system, with the X anions (typically chalcogens, like oxygen and sulfur) being arranged in a cubic close-packed lattice and the cations A and B occupying some or all of the octahedral and tetrahedral sites in the lattice.

As used herein, the term “layered structure” is meant to refer to a class of materials with the general formula AₓBO₂ where A is an alkali cation, B is a metal cation, and O is an oxygen anion. The O anions form a face-centered cubic (FCC) framework with octahedral and tetrahedral sites. These two environments are face sharing and form a topologically connected network.

As used herein, the term “particle separation methods” is meant to refer to methods to separate particles based on differences in size, shape, physical or chemical properties of the particles. Solid particles, such as cathode materials described herein, are typically separated by their dimensions (size) using such methods as wet or dry sieving or screening, classifiers, or cyclones.

As used herein, the term “solid-electrolyte interphase (SEI)” is meant to refer to a thin layer that is formed on the surface of the anode from the electrochemical reduction of the electrolyte and plays a crucial role in the long term cyclability of a lithium-based battery. The SEI is typically about 100-120 nm thick, and is mainly composed of various inorganic components, such as lithium carbonate (Li₂CO₃), lithium fluoride (LiF), lithium oxide (Li₂O), lithium hydroxide (LiOH), as well as some organic components such as lithium alkyl carbonates.

As used herein, the term “anti-foaming agent” is a chemical additive that reduces and hinders the formation of foam in industrial process liquids.

As used herein, the term “calcine” means to expose to strong heat. This may occur in a conventional gas fired or electrical furnace or through other means such as flame pyrolysis, plasma pyrolysis, or a dynamic recrystallization process, such as Geometric Dynamic Recrystallization (GDRX).

As used herein, the term “fatty acid” is meant to refer to a carboxylic acid with an aliphatic chain, which is either saturated or unsaturated.

Exemplary Embodiments

The present disclosure relates to methods to manufacture particulate metal oxide and mixed metal oxides. As the preferred method, a one-pot method is disclosed where an aqueous metal compound solution, first basic solution, and a second basic solution are pumped into a reaction vessel filled with heated water. A predetermined pH range is maintained in the reaction vessel. This is followed by sequential addition of a lithium-based compound and then one or more fatty acids to the reaction vessel. In some embodiments, the solutions may be pumped in simultaneously. In other embodiments, the process may be a continuous process. A precipitate is filtered and washed and then dried. The dried precipitate is calcined in the presence of oxygen/air to yield calcined lithium metal oxides or lithium mixed metal oxides that may be used as the cathode material component in lithium-ion batteries. The calcined oxides can be sized to produce the particulate metal oxide having a predetermined average particle size.

In various exemplary embodiments, the metal oxides comprise the general formula LiMXOY where M is a transition metal, including nickel (Ni), manganese (Mn), cobalt (Co), iron (Fe), aluminum (Al), titanium (Ti), etc., and where x=1, y=2 or where x=2 and y=4.

In other various exemplary embodiments, the lithium mixed metal oxides may comprise two different metals with general formula Li(M1)ₓ(M2)_{y}O₂ where M1 and M2 are different metals and where M1 and M2 are Ni, Mn, Co, or Al, and further where x+y=1.

In other various exemplary embodiments, lithium mixed metal oxides may comprise three different metals with general formula Li(M1)ₓ(M2)_{y}(M3)_{z}O₂ where M1 is Ni, M2 is Mn, and M3 is Co, or where M1 is Ni, M2 is Co and M3 is aluminum (Al), and where x+y+z=1.

In other various embodiments, dopants, or excess lithium (Li) may additionally be added to the reaction vessel. The dopants preferably replace a portion of the metal component in the particulate lithium metal oxides.

In other various embodiments, fluorine-based additives may be added to the reaction vessel in order to produce fluorine doped lithium metal oxides and lithium mixed metal oxides. The fluorine is incorporated into the oxygen lattice to enhance cycling stability.

In other various exemplary embodiments, the particulate lithium metal oxides may further comprise a coating. The coating is used to stabilize or improve the cycling and electrical conductivity properties of the particles.

Lithium Metal Oxides

The following embodiments relate to a method to manufacture a metal oxide, in particular a lithium metal oxide.

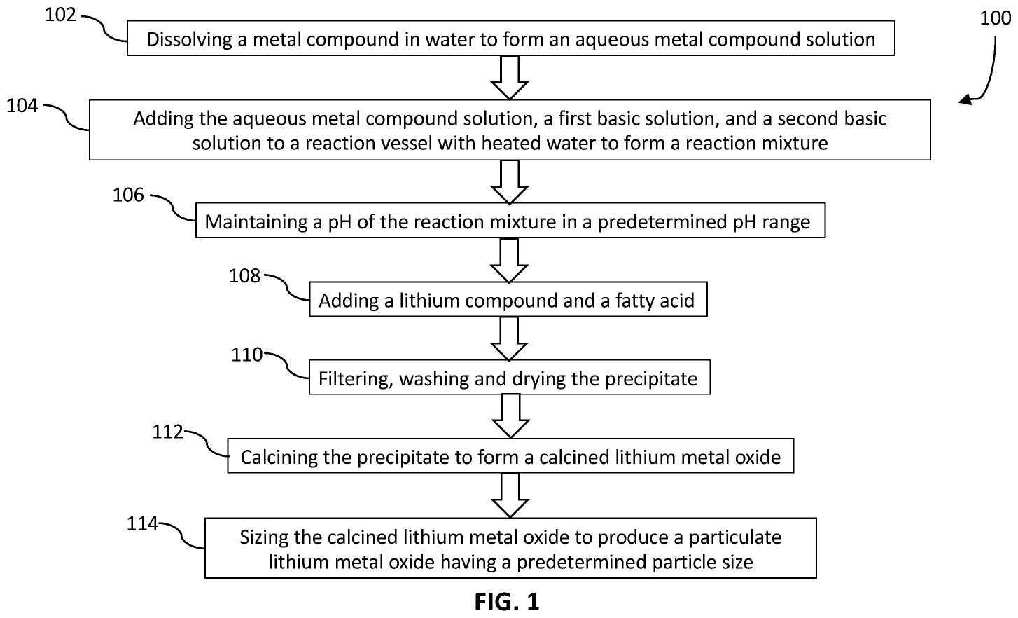

FIG. 1 is a block diagram of a one-pot method 100 to manufacture a particulate lithium metal oxide, according to an embodiment of the disclosure. In a first step 102, a metal compound is dissolved in water to form an aqueous metal compound solution. The metal compound comprises an anionic portion wherein the anionic portion comprises hydroxide, carbonate, acetate, alkoxide, oxalate, nitrate, nitride, sulfate, or oxide. The metal component M in the metal compound may preferably be Ni, Mn, or Co. The metal component may be, more specifically, in the form of metal ions such as Ni(II), Mn(II), or Co(II). The metal component may also be selected from the group consisting of aluminum (Al), titanium (Ti), iron (Fe), vanadium (V), magnesium (Mg), zirconium (Zr), tungsten (W), tantalum (Ta), and boron (B). The metal compound may be provided from a recycled cathode, recycled metal oxide, or recycled metal hydroxide. For example, the feed metal compound material source may be collected from recycling of lithium metal batteries or from other industrial sources. In order to balance the stoichiometry, virgin metal oxides or metal hydroxides may be added to the recycled metal oxides or metal hydroxides synthesis to maintain a target stoichiometry.

Step 104 in the method 100 to manufacture a lithium metal oxide is to add the metal compound solution along with a first basic solution and a second basic solution to a reaction vessel with heated water to form a reaction mixture. The reaction vessel is equipped with a pH probe, temperature probe, heating mantle, and an inert gas inlet. The inert gas may be nitrogen or argon. The reaction vessel may further comprise an overhead stirrer or one or more baffles to enhance agitation of the solution. Agitation of the reaction mixture can be used to improve mixing of the components and may be used to control particle size and morphology. The water in the reaction vessel may be heated to a temperature in the range of 40-95° C. before addition of the various solutions. The first or second basic solution can be the same or different and comprises potassium hydroxide, sodium hydroxide, sodium carbonate, potassium carbonate, ammonium carbonate, or ammonium hydroxide. In some embodiments, only one basic solution is added instead of two different basic solutions. Heat and stirring may be continuously applied to the reaction mixture under an inert atmosphere. The reaction mixture may be stirred at a speed in the range of about 100-2000 rpm.

During addition of the basic and metal compound solutions, the pH of the reaction mixture is maintained 106 within a predetermined range. The pH range may be about 7-13. More preferably, the maintained pH range may be about 8-12, or about 10-12. The pH range may be controlled by the addition or reduction of one or both of the basic solutions.

In the depicted embodiment, the first basic solution may be added to the reaction vessel at a first rate R, the second basic solution is added at a rate of about 0.05-0.5 ×R, and the aqueous metal compound solution is added at a rate of about 0.1-2 ×R. The first basic solution may be added at a first rate R over a period of 10-30 hours.

Step 108 in the method 100 to manufacture a lithium metal oxide, as shown in FIG. 1, is to add one or more lithium compounds and one or more fatty acids. The lithium compounds have a general formula of LiₓA wherein x is 1-3 and where A is an anionic component. The lithium compounds may be pre-mixed before addition to the reaction mixture or may be added in a sequential manner. The addition of the compounds may be added in one portion or may be added over a predetermined period of time. The lithium compound may be added at a molar ratio of about 1-2 ×the moles of transition metal in the metal compound. Heat and stirring may be continuously applied under an inert atmosphere to the reaction mixture. After addition of one or more lithium compounds, the reaction mixture is stirred for a period of time before the one or more fatty acids are added to the reaction mixture.

The anionic component (A) in the lithium and metal compounds is selected from the group consisting of hydroxide, carbonate, acetate, alkoxide, oxalate, nitrate, nitride, sulfate, acetylacetonate, and oxide. A mixture of one or more lithium and metal compounds with different anionic components (A) may be added to the heated mixture or only a single anionic component may be added. The lithium and metal compounds may have the same or different anionic components.

The one or more fatty acids added at step 108 may be selected from oleic acid, linoleic acid, myristoleic acid, palmitoleic acid, sapienic acid, elaidic acid, vaccenic acid, linoelaidic acid, α-linolenic acid, linolenic acid, arachidonic acid, eicosapentaenoic acid, erucic acid, propionic acid, butyric acid, valeric acid, hexanoic acid, heptanoic acid, octanoic acid, caprylic acid, capric acid, lauric acid, myristic acid, palmitic acid, stearic acid, arachidic acid, behenic acid, lignoceric acid, cerotic acid, or docosahexaenoic acid, and combinations thereof. Two fatty acids may be mixed together in a molar ratio of about 1-20:1. The fatty acid may be added at a rate of about 2-6 ×R over a period of time. The period of time may be about 15 min to about 4 hours. The fatty acid may be added at a molar ratio of about 0.1-2 ×moles of lithium added. Once the fatty acid is added, the reaction may be stirred for a period of time with continuous heating and under an inert atmosphere. The period of time may be about 15 min to up to about 5 hours. The one or more fatty acids may be filtered before addition to the reaction mixture.

In some embodiments, the metal compound solution, one or more basic solutions, lithium compound solution, and the one or more fatty acids may be added simultaneously. The one or more fatty acids may be filtered before addition and an antifoaming agent may be added.

The next step 110 in the method 100 to manufacture a lithium metal oxide is to filter, wash and dry the precipitate that is formed in the reaction vessel. The precipitate may also be isolated using centrifugation. The precipitate may be washed with one or more portions of water (such as distilled water) or other liquid. The precipitate may be dried in an oven or other drying apparatus. The precipitate may be spray dried. The oven may be heated to a temperature in the range of about 50-200° C. In some embodiments, the dried precipitate may be sized to achieve a desired particle size range. Sizing may comprise comminuting, sieving, classifying, milling, or a combination thereof. In some embodiments, the precipitate may not be dried but instead be added as a paste or slurry to a calcination device.

In some embodiments, the filtrate remaining after filtration of the precipitate may be recycled and reused. The filtrate contains unused fatty acids and any anti-foaming agents that may have been added. Additionally, the filtrate may also contain dissolved and unreacted metals compounds and lithium salts. Recycling the filtrate may increase the overall yield of the process and lower the cost of production of the lithium metal oxide.

In some embodiments, one or more optional dopants may be added to the reaction mixture. The dopant may be pre-mixed with the metal compound solution before addition to the reaction vessel. The dopant is preferably a transition metal in ionic form. The dopant may be selected from the group consisting of aluminum (Al), titanium (Ti), zirconium (Zr), magnesium (Mg), boron (B), tungsten (W), molybdenum (Mo), vanadium (V), tantalum (Ta), gallium (Ga), niobium (Nb), zinc (Zn), cesium (Cs), and calcium (Ca). The one or more dopants preferably replaces a portion of the metal component in the lithium metal oxide.

In some embodiments, a fluorine-based dopant may be added to the reaction mixture. The fluorine is added to replace oxygen atoms with fluorine atoms in the oxygen lattice to improve electrochemical performance and stability. The fluorine-based dopant may be a fluorinated polymer such as polyvinylidene fluoride (PVDF), poly(vinyl fluoride) (PVF), poly(ethylenetetrafluoroethylene) (ETFE), perfluoropolyether (PFPE), or poly(tetrafluoroethylene) (PTFE). The fluorine-based dopant may be a fluoride salt such as LiF, NH₄F, NaF, or NHₐR₄₋ₐF where R is an alkyl group and where a=0-4. The fluorine-based dopant may be a transition metal fluoride (MF_{c}; where M is a transition metal and c=1-3) such as NiF₂, AlF₃, MnF₂, or CoF₂ or a combination thereof. The fluorine may be added up to about a 10% concentration of the oxygen lattice such that the resulting composition may be LiMF™O₂™. where ™is ≤0.2 and M may be one or more transition metals such as Ni, Mn, Al, or Co.

In some embodiments, a stoichiometric excess of the lithium compound may be added to the reaction mixture. This is to make up for any lithium that may sublimate and be lost during a calcining step. An excess of lithium may also be desired such as when a battery cell proceeds through a formation process. Excess lithium may be beneficial to aid in the initial formation of the solid-electrolyte interphase (SEI) layer during the formation process and during continual cycling.

In some embodiments, a de-emulsifying, anti-foaming agent, such as ethylene glycol, propylene glycol, butanediol, ethanol, or methanol in order to de-emulsify the one or more fatty acids is added to one or both of the basic solutions in a range of about 5-20 wt %. The anti-foaming agent may also be added to the fatty acids before being added to the reaction mixture.

Step 112 in the method 100 to manufacture a lithium metal oxide is to calcine the dried precipitate to form a calcined lithium metal oxide. The dried precipitate may be calcined in a furnace, such as a tube furnace, atmosphere-controlled muffle furnace, or a rotary calciner. The calcining process may comprise the following steps:
placing the dried precipitate in a calciner or furnace;
heating the dried precipitate to about 300-400° C. at a ramp rate of about 0.1 to about 30° C./min and holding for about 0.5 to 10 hours;
heating the dried precipitate to about 450-600° C. at a ramp rate of about 0.1 to about 15° C./min and holding for about 0.5 to about 10 hours; and
heating the dried precipitate to about 700-900° C. at a ramp rate of up to about 0.1 to about 10° C./min and holding for about 0.5 to 15 hours.

The dried precipitate is preferably calcined in an atmosphere that includes oxygen. The atmosphere may be air or oxygen. The atmosphere may be a gas that comprises oxygen such as a mixture of nitrogen or argon and oxygen.

Other heat treatment methods may be used in the calcining process to produce the cathode materials described herein, such as flame pyrolysis, plasma pyrolysis, or dynamic recrystallization process. The heat treatment process may also comprise a multi-stage processing system to convert one or more precursor compounds into a cathode material wherein the system comprises a mist generator, a drying chamber, one or more gas-solid separators, and one or more in-line reaction modules further comprising one or more gas-solid feeders, one or more gas-solid separators, and one or more reactors.

The calcined lithium metal oxide is then actively or passively cooled to form a particulate lithium metal oxide that is preferably suited to be used as a cathode material in a lithium-ion battery. The lithium metal oxide may have the general formula LiMXOY wherein M is manganese, nickel, or cobalt and wherein x is 1 or 2 and wherein y is 2 or 4. The lithium metal oxide may have a spinel or layered structure. The lithium metal oxide may be polycrystalline or monocrystalline (may also be referred to as single crystalline) or a combination thereof.

The next step 114 in the method 100 to manufacture a lithium metal oxide is sizing the calcined lithium metal oxide to form a particulate lithium metal oxide having a predetermined particle size. The particulate lithium metal oxide may be comminuted. The particle sizing may be carried out by a variety of particle separation methods. The lithium metal oxide preferably has an average particle size in the range of about 1 to 1000 microns, or more preferably in the range of about 1 to 100 microns, or even more preferably in the range of about 1 to 20 microns.

In some embodiments, a coating or layer may be further deposited onto the surface of the lithium metal oxide. The coating can influence particle interfacial properties in beneficial ways. The coating can also prevent the cathode materials from direct contact with the electrolyte and avoid decomposition or oxidation of the electrolyte which leads to improved cycle and storage life of the battery. The coating may comprise a metal oxide such as Al₂O₃, ZrO₂, TiO₂, B₂O₃, MoO₃, or WO₃. The coating may also comprise a phosphate, fluorides such as AlF₃, MgF₂, CeF₂, or CaF₂, or conducting polymer. The coating may also comprise a solid electrolyte. The coating may comprise a fast ionic conductor such as LiAlO₂, Li₃ZrO₂, Li₂O-2B₂O₃, Li₃PO₄, Li₂ZrO₃, or Li₂WO₄. The coating may also comprise a second lithium metal oxide material.

A coating may be deposited onto the lithium metal oxide such by dispersing in a solution of the coating precursor materials, be tumbled with solid precursor materials or spray dried. In both methods, the lithium metal oxides with the coating of precursor materials are then calcined to form a coating on the surface. The coating may be a continuous or non-continuous coating. The coating may have a thickness in the range of preferably about 1 to about 100 nm, more preferably about 1 to about 50 nm or even more preferably about 1 to about 20 nm.

In an embodiment, the lithium metal oxide may be dispersed in a solution comprising coating precursor materials to form a dispersion. The dispersion may be dried, such as by spray drying to flash dry the lithium metal oxide particles with a uniform coating of precursor materials. The particles may then be calcined to form an adhered coating on the surface.

In another method to form a coating on the lithium metal oxide surface, the lithium metal oxide may be tumbled with solid precursor materials followed by calcining to form a surface layer. In one specific example, forming the outer layer of Li and Co-rich material on the lithium metal oxide surface comprises tumbling the metal oxide with Li and Co-containing precursor materials to form a coated lithium metal oxide; and then calcining the coated lithium metal oxide to form a lithium metal oxide with a Li and Co-rich layer such that the Co does not substantially migrate enter the structure of the metal oxide portion where it may become a dopant in the primary structure and negatively impact the performance of the cathode. This may be achieved by calcining the coating at as low a temperature and short of time as possible.

In some embodiments, atoms from the coating layer may migrate into the outer surface of the cathode particle and act as a dopant that may improve ionic and electronic conductivity.

Lithium Mixed Metal Oxides

The following embodiments relate to a method to manufacture a mixed metal oxide, in particular a lithium mixed metal oxide. The lithium mixed metal oxide may be monocrystalline or polycrystalline.

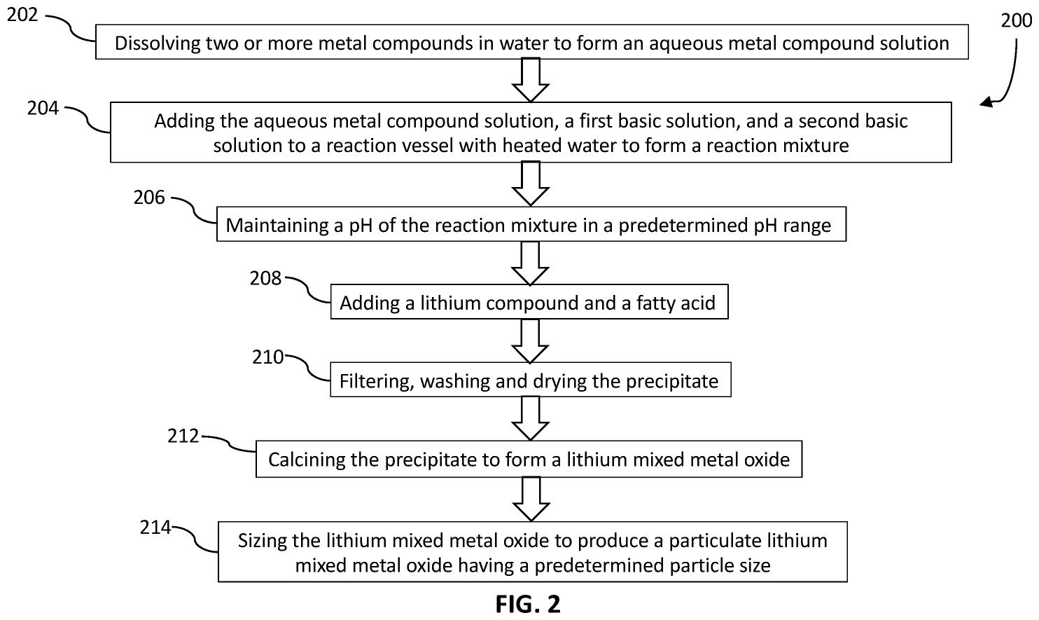

FIG. 2 is a block diagram of a one-pot method 200 to manufacture a particulate lithium mixed metal oxide, according to an embodiment of the disclosure. The method illustrated in FIG. 2 is similar to method 100 for producing a lithium metal oxide. In method 200, the first step 202 is to dissolve two or more metal compounds with different metal centers in water to form an aqueous metal compound solution. A dopant may also be added to the metal compound solution. This is followed by adding the metal compound solution along with first and second basic solutions to heated water in a reaction vessel to form a reaction mixture 204 while the pH of the reaction mixture is maintained 206 as previously described herein. The solutions may be added to the reaction vessel simultaneously or sequentially. A lithium compound and one or more fatty acids are then added 208 to the reaction mixture. The fatty acids may be filtered before addition to remove any solid contaminants or crystallized fatty acids. A precipitate is filtered, washed and dried 210 to form a dried precipitate that is calcined to form a lithium mixed metal oxide 212 with formula Li(M1)ₓ(M2)₁₋ₓO₂. Transition metals M1 and M2 may be selected from the group consisting of nickel, manganese, cobalt, and aluminum. The lithium mixed metal oxide is optionally sized to produce a particulate lithium mixed metal oxide having a predetermined particle size 214.

In some embodiments, a de-emulsifying, anti-foaming agent, such as ethylene glycol, propylene glycol, butanediol, ethanol, or methanol in order to de-emulsify the one or more fatty acids is added to one or both of the basic solutions in a range of about 5-20 wt %.

In some embodiments, the dried precipitate may also be sized before calcining. Sizing may comprise comminution, classifying, or milling.

Lithium mixed metal oxides with general formula Li(M1)ₐ(M2)_{b}(M3)_{c}O₂ wherein a+b+c =1 may also be synthesized using method 200 outlined in FIG. 2. In step 202, a third metal compound is dissolved in the metal compound solution wherein metals M1, M2, and M3 are all different.

Lithium mixed metal oxides with general formula Li(M1)ₐ(M2)_{b}(M3)_{c}(M4)_{d}O₂ wherein a+b+c+d=1 may also be synthesized using method 200 illustrated in FIG. 2. In step 202, a third metal compound and a fourth metal compound are dissolved in the metal compound solution wherein metals M1, M2, M3, and M4 are all different. Metals M1, M2, M3, and M4 may preferably be selected from the group consisting of nickel, manganese, cobalt, and aluminum. Metals M1, M2, M3, and M4 may also be selected from the group consisting of Ti, Zr, Mg, B, F, W, Mo, V, Ta, Ga, Nb, and Ca.

Step 212 in the method 200 to manufacture a lithium mixed metal oxide is to calcine the dried precipitate to form a calcined lithium mixed metal oxide. The dried precipitate may be calcined in a furnace, such as a tube furnace, atmosphere-controlled muffle furnace, or a rotary calciner. The following calcining process to form a polycrystalline or monocrystalline lithium mixed metal oxide may comprise the following steps:
placing the dried precipitate in a calciner or furnace;
heating the dried precipitate to about 300-400° C. at a ramp rate of about 0.1 to about 30° C./min and holding for about 0.5 to 10 hours;
heating the dried precipitate to about 450-600° C. at a ramp rate of about 0.1 to about 15° C./min and holding for about 0.5 to about 10 hours; and
heating the dried precipitate to about 700-1000° C. at a ramp rate of up to about 0.1 to about 10° C./min and holding for about 0.5 to 15 hours.

In some embodiments, an initial low temperature heating step may be added before the step of heating to the 300-400° C. range as disclosed previously herein in steps 112 and 212. The initial heating step may comprise heating to about 150-250° C. at a ramp rate of about 0.1 to about 15° C./min and holding for about 0.5 to 10 hours. This temperature, ramp rate and hold time may be dependent upon which type of fatty acid is used. For higher boiling point fatty acids, this initial heating step may not be necessary. For lower boiling point fatty acids this may be necessary such as for propionic acid, butyric acid, valeric acid, hexanoic acid, or heptanoic acid in order to remove the fatty acids before proceeding with further steps in the calcination process.

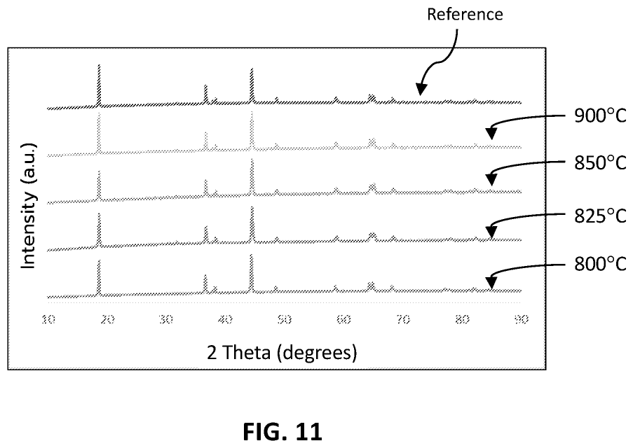

It is observed that adding an initial low temperature heating step and increasing the final temperature results in a more crystalline pure phase. FIG. 11 is x-ray diffraction data showing the effect of higher final calcination temperatures on the crystallinity of LiNi_{0.6}Mn_{0.2}Co_{0.2}O₂. This behavior may be observed in other various compositions such as in LiNi_{0.8}Mn_{0.1}Co_{0.1}O₂, LiNi_{0.33}Mn_{0.33}Co_{0.33}O₂, or LiNi_{0.9}Mn_{0.05}Co_{0.05}O₂. The range tested is 800-900° C. compared to a standard reference. As the final temperature increases, the material becomes more phase pure.

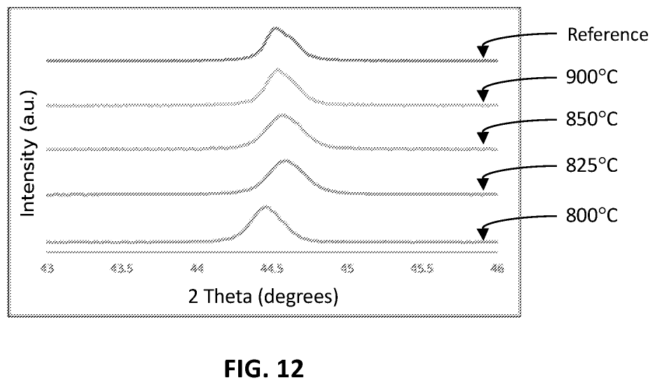

FIG. 12 is a close-up of the region at 45 degrees showing the effect of higher final calcination temperatures on the crystallinity of LiNi_{0.6}Mn_{0.2}Co_{0.2}O₂. This view further supports the effect of higher final calcination temperatures on the crystallinity of the material. This close-up view focuses on the 45 degree region where the peak increasingly splits showing the 104 plane of the crystal.

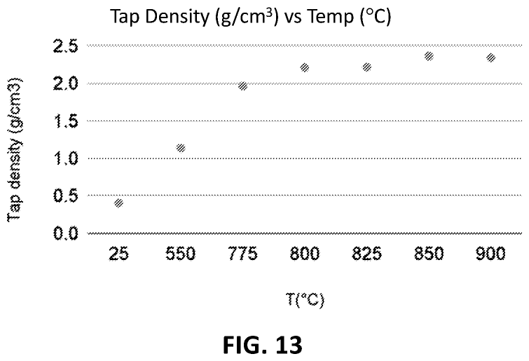

FIG. 13 is a plot of final calcination temperature versus tap density of LiNi_{0.6}Mn_{0.2}Co_{0.2}O₂. This plot illustrates the beneficial effect of final temperature on the tap density (g/cm³) of LiNi_{0.6}Mn_{0.2}Co_{0.2}O₂. The tap density plateaus at about 850° C.

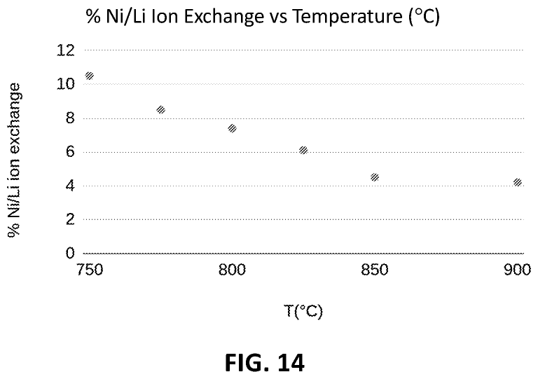

Higher final calcination temperature also has a beneficial effect on Ni/Li exchange. FIG. 14 is a plot of final calcination temperature versus % Ni/Li ion exchange of LiNi_{0.6}Mn_{0.2}Co_{0.2}O₂. The % Ni/Li ion exchange decreases with higher calcination temperature.

Continuous Process Procedure for the Synthesis of Lithium Metal and Mixed Metal Oxides

The following embodiments relate to a continuous manufacturing method for the synthesis of a lithium metal oxide or lithium mixed metal oxide. The metal oxides may be monocrystalline or polycrystalline.

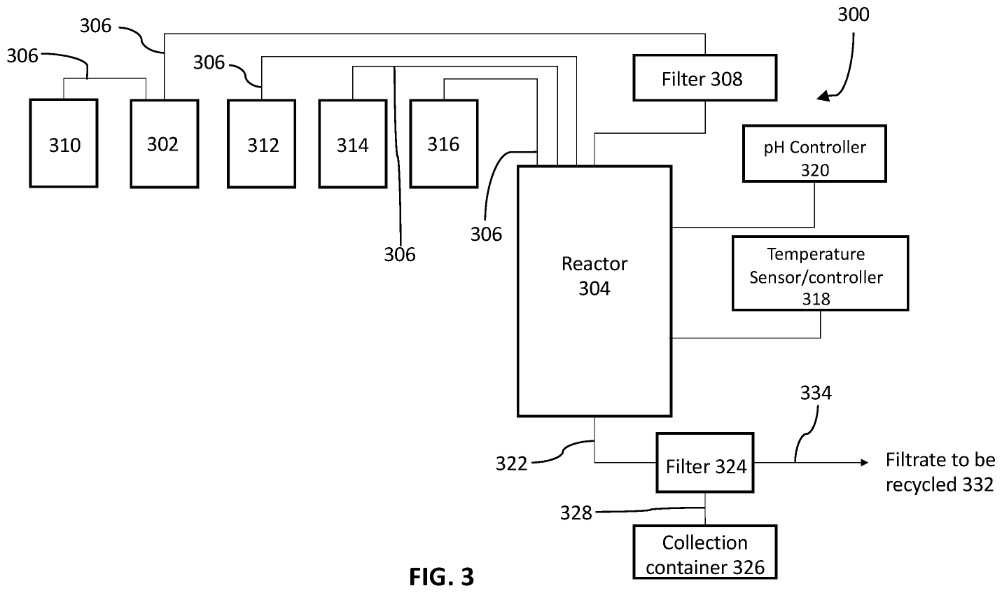

FIG. 3 is a schematic diagram illustrating a continuous manufacturing process for lithium metal and mixed metal oxides, according to an embodiment of the disclosure. A first vessel 302 is charged with one or more fatty acids. Before being delivered to the reactor 304 through a feed line 306, the fatty acids may pass through an optional filter 308, such as a 20 μm filter. The filter can remove solid contaminants or crystallized fatty acids. Vessel 302 is also in liquid communication with optional vessel 310. Vessel 310 may be charged with additives, acids, bases or other materials. Vessel 310 may comprise a de-emulsifying, anti-foaming agent, such as ethylene glycol, propylene glycol, butanediol, ethanol, or methanol in order to de-emulsify the one or more fatty acids in vessel 310 in a range of about 5-20 wt %. In some embodiments, anti-foaming agents from vessel 310 may instead be added directly to any of the other vessels 312, 314 or 316 or directly to reactor 304.

Vessel 312 may be charged with a lithium salt solution, such as an aqueous solution of lithium hydroxide. Vessel 314 may comprise a solution of one or more transition metal salts, such as metal acetates or metal sulfates. For example, a solution of Ni, Mn, Al, or Co sulfate, carbonate or acetate may be added. Vessel 316 may be charged with one or more bases, such as sodium hydroxide or potassium hydroxide or ammonia, to maintain a desired pH range in the reactor.

The reactor 304 may be a glass or stainless-steel reactor, such as a stainless steel 4L Pope Scientific continuous stirred tank reactor (CSTR). The reactor may have a jacket to be able maintain a temperature within a desired range by circulating heated or cooled liquid through the jacket using a circulator. The reactor may comprise an overhead stirrer to control a stirrer shaft to continuously and controllably agitate the solution within the reactor. The reactor may comprise an optional temperature sensor and controller 318. The reactor may also comprise an optional pH controller 318. The pH controller may be in electronic communication with vessel 316 to increase delivery of a basic solution through a feed line 306 if the pH falls below a predetermined limit. The reactor may further comprise an inlet and outlet to help in maintaining an inert atmosphere by flowing an inert gas through the reactor. In some embodiments, oxygen or air may flow through the reactor.

Once the reaction is finished, the solution may be pumped out of the reactor with a peristaltic pump or other type of pump. The solution may be pumped out of the bottom of the reactor as shown in FIG. 3 through exit line 322. System 300 further comprises an optional exit filter 324 to filter out precipitated product. The product may be further collected in collection container 326 that is in communication with filter 324 via line 328. Filtrate 332 that passes through filter 324 and filter exit line 334 may be disposed of or recycled and re-used to form a continuous and recyclable process.

Any of vessels 302, 310-316 may further be configured to be able to mix or stir or heat the contents within. Any of the vessels may be able to have an inlet and outlet to allow for inert gas such as nitrogen or argon to be cycled through to maintain an inert atmosphere. Any of the vessels may use a pump, such as a peristaltic pump, screw pump, gear pump, piston pump, or diaphragm pump. Any of the vessels may be in liquid communication with any of the other vessels, filters, collection containers, or reactor.

The various vessels in system 300 may be continually charged to continuously feed material into the reactor to continuously produce product. The vessels may be in liquid communication with further supply tanks or reservoirs that monitor concentration, conductivity, or spectroscopic properties of the solutions to determine if the concentrations of the various solutions to be pumped into the reactor are known and are kept in predetermined ranges.

Lithium Metal Phosphates

The following embodiments relate to a method to manufacture a metal phosphate, in particular a lithium metal phosphate.

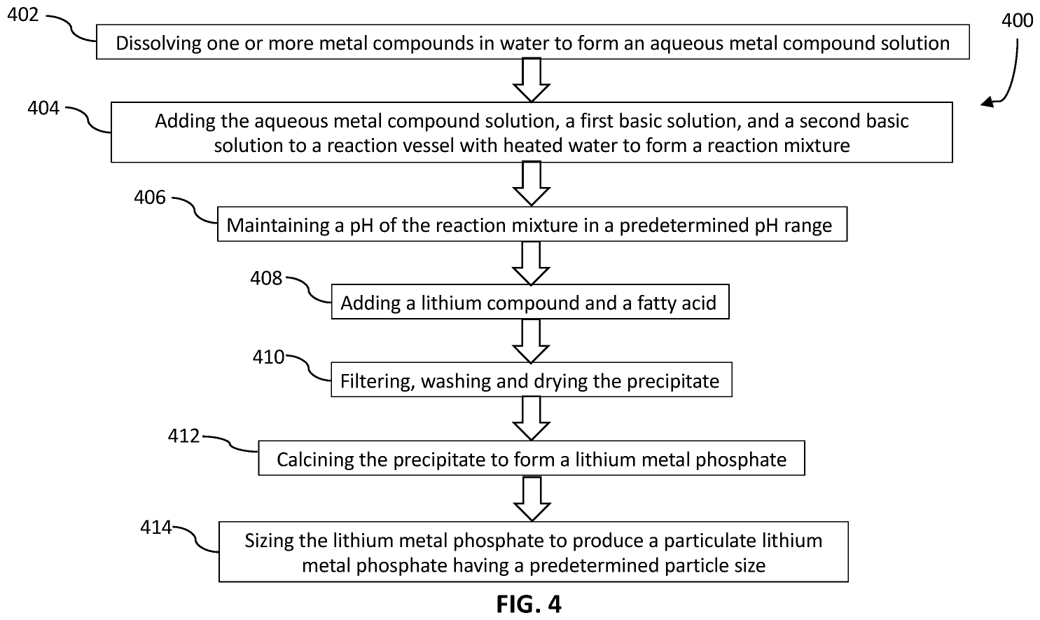

FIG. 4 is a block diagram of a one-pot method 400 to manufacture a particulate lithium metal phosphate, according to an embodiment of the disclosure. The method of manufacture of lithium metal phosphate is similar to that of methods 100, 200 disclosed herein for the synthesis of lithium metal oxides and lithium mixed metal oxides, respectively. Two or more metal compounds are dissolved in water to form an aqueous metal compound solution 402. The metal compound solution, a first basic solution and a second basic solution wherein one or both of the basic solutions comprise a phosphate-based compound are added to a reaction vessel with heated water 404 to form a reaction mixture. The basic solutions comprise one or more of (NH₄)₃PO₄, Na₃PO₄, Li₃PO₄, K₃PO₄, H(NH₄)₂PO₄, or H₂(NH₄)PO₄. The pH of the reaction mixture is maintained within a predetermined range 406 and the solutions may be added sequentially or simultaneously.

The reaction mixture is heated and stirred continuously and a lithium compound and one or more fatty acids are added 408. The lithium compound may comprise Li₃PO₄, Li₂HPO₄, or LiH₂PO₄. A precipitate is filtered, washed, and dried 410 and then calcined in an inert atmosphere, such as nitrogen or argon, to form a lithium metal phosphate 412 with general formula Li(M5)PO₄, where M5 is of iron, nickel, manganese, or cobalt. The lithium metal phosphate is sized to produce a particulate lithium metal phosphate having a predetermined particle size 414 suitable for use in a lithium-ion battery cell.

In some embodiments, a lithium mixed metal phosphate may be manufactured using the procedure in method 400. In step 402, two or more metal compounds may be added and dissolved in the aqueous metal compound solution with different metals to form a lithium mixed metal phosphate with general formula Li(M5)ₐ(M6)_{b}PO₄ where a+b=1, Li(M5)ₐ(M6)_{b}(M7)_{c}PO₄ where a+b+c=1, or Li(M5)ₐ(M6)_{b}(M7)_{c}(M8)_{d}PO₄ where a+b+c+d=1, and where M5, M6, M7, and M8 are selected from the group consisting of iron, nickel, manganese, and cobalt. Currently, iron is the preferred metal.

While a batch process has been depicted here, a continuous process, similar to that shown in FIG. 3, may also be used to make lithium metal phosphate. The various solutions and one or more fatty acids may be added simultaneously to the reactor.

Examples

The following are experimental syntheses of LiNi_{0.6}Mn_{0.2}Co_{0.2}O₂ using method 200 illustrated in FIG. 2. A metal acetate-based method and two different methods, A and B, to synthesize LiNi_{0.6}Mn_{0.2}Co_{0.2}O₂ using metal sulfate precursors and method 2 are disclosed. Additionally, experimental syntheses for LiNi_{0.6}Mn_{0.2}Co_{0.2}O₂, LiNi_{0.8}Mn_{0.1}Co_{0.1}O₂, and LiNi_{0.33}Mn_{0.33}Co_{0.33}O₂ are disclosed that use an initial low temperature heating step.

Synthesis of LiNi_{0.6}Mn_{0.2}Co_{0.2}O₂ 220 using Metal Acetate Compounds:

To a 1 L media bottle is added 24.884 g of nickel (II) acetate tetrahydrate, 8.170 g of manganese (II) acetate tetrahydrate, 8.303 g of cobalt (II) acetate tetrahydrate and 167 mL of distilled water. The metal acetates are stirred until they are all dissolved to form a metal compound solution. A 2 M NaOH solution is prepared by dissolving 12.24 g of NaOH in 153 mL of distilled water in a 1 L media bottle. A 1 L reaction vessel is assembled that is equipped with a pH probe, temperature probe, a bent adapter that connects a nitrogen line to the vessel, and a heating mantle. To the reaction vessel is added 100 mL of distilled water and is heated to 50° C. under a flow of nitrogen. The heated water in the reaction vessel is stirred at 800 rpm. To the heated and stirred water, the NaOH solution is pumped in at a rate of 0.128 mL/min, 27.817 mL of ammonium hydroxide (NH4OH) is pumped in at 0.023 mL/min, and the metal compound solution is pumped in at 0.14 mL/min to the reaction vessel, simultaneously, over a period of 20 h. During this time, the pH is monitored and kept at pH=11. If necessary, the pumping rate of the NaOH solution is varied to maintain the desired pH. After the 20 h period, 13.987 g of lithium hydroxide monohydrate (LiOH·H2O) is added to the reaction vessel and is stirred for 1 h. The temperature is kept constant and the stirring speed is reduced to 400 rpm. A 55.3 mL portion of a fatty acid mixture of 5 wt % oleic acid, 5% palmitic acid, 4% stearic acid, 5% linoleic acid and 1% linolenic acid is filtered and added to the reaction vessel at a rate of 0.6 mL/min over a period of about 1.5 h. After complete addition, the contents of the reaction vessel were stirred for another 1 h. The formed precipitate is then filtered and washed three times with distilled water then dried in a 100° C. oven. The dried precipitate is then calcined in the presence of oxygen to form the lithium mixed metal oxide LiNi_{0.6}Mn_{0.2}Co_{0.2}O₂. The calcination profile used is as follows: the dried precipitate is heated to 350° C. at a rate of 10° C./min and held for 3 h, heated to 550° C. at 2° C./min and held for 3 h, then heated to 780° C. at 2° C./min and held for 5 h. The mixed metal oxide is then cooled to room temperature.

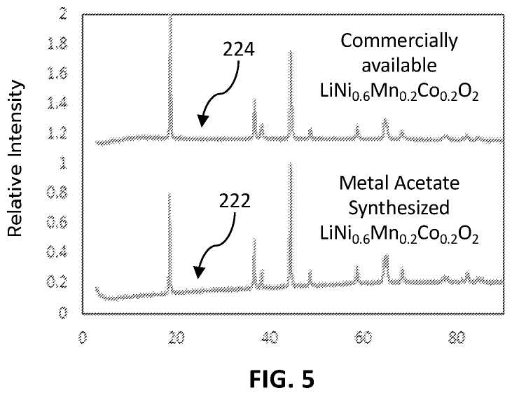

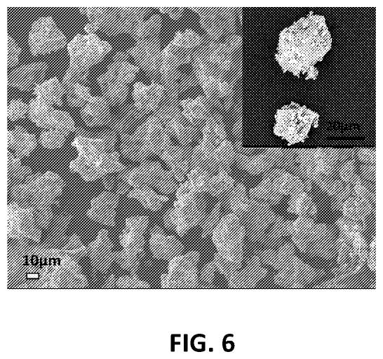

FIG. 5 is the x-ray diffraction pattern 222 for LiNi_{0.6}Mn_{0.2}Co_{0.2}O₂ 220 synthesized from metal acetate precursors. For comparison purposes, the diffraction pattern 224 for commercially available LiNi_{0.6}Mn_{0.2}Co_{0.2}O₂ is also shown. FIG. 6 is an SEM image of LiNi_{0.6}Mn_{0.2}Co_{0.2}O₂ 220 particles synthesized from metal acetate precursors.

Synthesis A of LiNi_{0.6}Mn_{0.2}Co_{0.2}O₂ 230 using Metal Sulfate Compounds:

To a 1L media bottle is added 78.858 g of nickel (II) sulfate hexa hydrate, 16.902 g of manganese (II) sulfate monohydrate, 28.110 g of cobalt (II) sulfate heptahydrate and 200 mL of distilled water. The metal sulfates are stirred until they are all dissolved to form a metal compound solution. A 2M NaOH solution is prepared by dissolving 36.72 g of NaOH in 459 mL of distilled water in a 1L media bottle. A 1L reaction vessel is assembled that is equipped with a pH probe, temperature probe, a bent adapter that connects a nitrogen line to the vessel, and a heating mantle. To the reaction vessel is added 100 mL of distilled water and is heated to 50° C. under a flow of nitrogen. The heated water in the reaction vessel is stirred at 800 rpm. To the heated and stirred water, the NaOH solution is pumped in at a rate of 0.459 mL/min, 83.452 mL of ammonium hydroxide (NH₄OH) is pumped in at 0.083 mL/min, and the metal compound solution is pumped in at 0.20 mL/min to the reaction vessel, simultaneously, over a period of 16.7 h. During this time, the pH is monitored and kept at pH=11. If necessary, the pumping rate of the NaOH solution is varied to maintain the desired pH. After the 16.7 h period, 41.962 g of lithium hydroxide monohydrate (LiOH·H₂O) is added to the reaction vessel and is stirred for 1 h. The temperature is kept constant and the stirring speed is reduced to 400 rpm after the 1h. A 166 mL portion of a fatty acid mixture of 5 wt % of oleic acid, 5% palmitic acid, 4% stearic acid, 5% linoleic acid and 1% linolenic acid is filtered and added to the reaction vessel at a rate of 0.6 mL/min. After complete addition, the contents of the reaction vessel were stirred for another 1 h. The formed precipitate is then filtered and washed three times with distilled water then dried in a 100° C. oven. The dried precipitate is then calcined in the presence of oxygen to form the lithium mixed metal oxide LiNi_{0.6}Mn_{0.2}Co_{0.2}O₂. The calcination profile used is as follows: the dried precipitate is heated to 350° C. at a rate of 10° C./min and held for 3 h, heated to 550° C. at 2° C./min and held for 3 h, then heated to 780° C. at 2° C./min and held for 5 h. The mixed metal oxide is then cooled to room temperature.

Synthesis B of LiNi_{0.6}Mn_{0.2}Co_{0.2}O₂ 230 using Metal Sulfate Compounds:

To a 1 L media bottle is added 39.429 g of nickel (II) sulfate hexahydrate, 8.451 g of manganese (II) sulfate monohydrate, 14.055 g of cobalt (II) sulfate heptahydrate and 100 mL of distilled water. The metal sulfates are stirred until they are all dissolved to form a metal compound solution. A 2 M NaOH solution is prepared by dissolving 18.36 g of NaOH in 230 mL of distilled water in a 1 L media bottle. A 1 L reaction vessel is assembled that is equipped with a pH probe, temperature probe, a bent adapter that connects a nitrogen line to the vessel, and a heating mantle. To the reaction vessel is added 100 mL of distilled water and is heated to 50° C. under a flow of nitrogen. The heated water in the reaction vessel is stirred at 800 rpm. To the heated and stirred water, the NaOH solution is pumped at a rate of 0.4 mL/min, 41.726 mL of ammonium hydroxide (NH₄OH) is pumped in at 0.04 mL/min, and the metal compound solution is pumped in at 0.2 mL/min to the reaction vessel. During this addition time, the pH is monitored and kept at pH=11. If necessary, the pumping rate of the NaOH solution is varied to maintain the desired pH. After 1 h, a 4 M solution of lithium hydroxide formed by dissolving 12.589 g of lithium hydroxide monohydrate (LiOH·H₂O) in 75 mL of water is added to the reaction vessel at a rate of 1.25 mL/min. After the LiOH solution has been added, a 49.8 mL portion of a fatty acid mixture of 5 wt % oleic acid, 5% palmitic acid, 4% stearic acid, 5% linoleic acid and 1% linolenic acid is filtered and added to the reaction vessel at a rate of 2.0 mL/min. After complete addition, the formed precipitate is then filtered and washed three times with distilled water then dried in a 100° C. oven. The dried precipitate is then calcined in the presence of oxygen to form the lithium mixed metal oxide LiNi_{0.6}Mn_{0.2}Co_{0.2}O₂. The calcination profile used is as follows: the dried precipitate is heated to 350° C. at a rate of 10° C./min and held for 3 h, heated to 550° C. at 10° C./min and held for 5 h, then heated to 780° C. at 2° C./min and held for 7 h. The mixed metal oxide is then cooled to room temperature.

Synthesis of LiNi_{0.6}Mn_{0.2}Co_{0.2}O₂ 250 using Metal Sulfate Compounds and a Low Temperature Heating Step:

A 1 L reaction vessel is assembled that is equipped with a pH probe, temperature probe, a bent adapter that connects a nitrogen line to the vessel, a heating mantle, and an overhead stirring shaft. The reaction vessel is charged with 50 mL of distilled water and is heated to 50° C. under a flow of nitrogen. Nitrogen is added to allow continuous flushing of the atmosphere. The overhead shaft is started at 300 rpm. All three metal sulfates are added to a first 100 mL media bottle (bottle A); 6.309 g of nickel (II) sulfate hexahydrate, 1.352 g of manganese (II) sulfate monohydrate, 2.249 g of cobalt (II) sulfate heptahydrate and brought up to a final volume of 100 mL by addition of distilled water. The metal sulfates are stirred until they are all dissolved to form a metal compound solution. A second 100 mL media bottle (bottle B) is charged with 6.4 grams of NaOH solution and 30 mL of distilled water and mixed until it is all dissolved. To bottle B is further added 6.8 mL of ammonium hydroxide mixed and taken to a final volume of 50 mL by addition of distilled water and 5 ml of ethylene glycol and mixed well. A third 100 mL media bottle (bottle C) is charged with 2.350 g of lithium hydroxide monohydrate and 30 mL of distilled water and mixed until all the lithium hydroxide has dissolved. To bottle C is further added 6.68 mL of ammonium hydroxide, 5 mL of ethylene glycol, mixed and taken to a final volume of 50 mL with distilled water. The final 100 mL media bottle (bottle D) is charged with a fatty acid mixture of 85wt % oleic acid, 5% palmitic acid, 4% stearic acid, 5% linoleic acid and 1% linolenic acid and filtered. The addition of all the solutions from bottles A-D are such that they are added at different rates, but approximately keep the same molarity of addition. All media solutions are stirred to make sure they are homogeneous through the reaction. The pump rates of the different media from bottles A-D are as follows; bottle A=0.21 mL/min, bottle B=0.21 m, bottle=0.21 mL/min, and bottle D=0.09 mL/min. During this addition time, the pH is monitored and kept at approximately pH=11. If necessary, the pumping rate of the NaOH solution is varied to maintain the desired pH level. After complete addition, the formed precipitate is then filtered and washed three times with distilled water then dried in a 100° C. oven. The dried precipitate is then ground and calcined in the presence of oxygen or air to form the lithium mixed metal oxide LiNi_{0.6}Mn_{0.2}Co_{0.2}O₂. The calcination profile used is as follows: the dried precipitate is heated to 220° C. at a rate of 2° C./min and held for 5 hours, heated to 350° C. at a rate of 2° C./min and held for 5 h, heated to 550° C. at 2° C./min and held for 5 h. The material is then cooled down and ground again. For the final heating profile, the material is then heated to 850° C. at 2° C./min and held for 5 h. The mixed metal oxide is then cooled to room temperature and ground again.

Synthesis of LiNi_{0.8}Mn_{0.1}Co_{0.1}O₂ 260 using Metal Sulfate Compounds and a Low Temperature Heating Step:

A 1 L reaction vessel is assembled that is equipped with a pH probe, temperature probe, a bent adapter that connects a nitrogen line to the vessel, a heating mantle, and an overhead stirring shaft. The reaction vessel is charged with 50 mL of distilled water and is heated to 50° C. under a flow of nitrogen. Nitrogen is added to allow continuous flushing of the atmosphere. The overhead shaft starts at 300 rpm. All three metal sulfates are added to a first 100 mL media bottle (bottle A); 6.309 g of nickel (II) sulfate hexahydrate, 0.507 g of manganese (II) sulfate monohydrate, 0.8433 g of cobalt (II) sulfate heptahydrate and brought up to a final volume of 100 mL with distilled water. The metal sulfates are stirred until they are all dissolved to form a metal compound solution. A second 100 mL media bottle (bottle B) is charged with 6.4 g of NaOH solution and 30 mL of distilled water and mixed until it all is dissolved. To media bottle B is further added 6.8 mL of ammonium hydroxide mixed and taken to a final volume of 50 mL with distilled water, 5 mL of ethylene glycol and mixed well. A third 100 mL media bottle (bottle C) is charged with 1.384 g of lithium hydroxide monohydrate and 30 mL of distilled water and is mixed until all the lithium hydroxide is dissolved. To media bottle C is further added with 6.68 mL of ammonium hydroxide, mixed and taken to a final volume of 50 mL. The final media 100 mL bottle (bottle D) is charged with a fatty acid mixture of 85 wt % oleic acid, 5% palmitic acid, 4% stearic acid, 5% linoleic acid and 1% linolenic acid and is filtered. The addition of all the solutions are such that they are added at different rates, but approximately keep the same molarity of addition. All media solutions are stirred to make sure they are homogeneous through the reaction. The pump rates of the different media are as follows: bottle A=0.21 mL/min, bottle B=0.21 mL/min, bottle C=0.21 mL/min, and bottle D=0.09 mL/min. During this addition time, the pH is monitored and kept at approximately pH=11. If necessary, the pumping rate of the NaOH solution is varied to maintain the desired pH range. After complete addition, the formed precipitate is then filtered and washed three times with distilled water then dried in a 100° C. oven. The dried precipitate is ground and calcined in the presence of oxygen to form the lithium mixed metal oxide LiNi_{0.8}Mn_{0.1}Co_{0.1}O₂. The calcination profile used is as follows: the dried precipitate is heated to 220° C. at a rate of 2° C./min and held for 5 hours, heated to 350° C. at a rate of 2° C./min and held for 5 h, heated to 550° C. at 2° C./min and held for 5 h. The material is then cooled down and ground again. For the final heating profile, the material is then heated to 930° C. at 2° C./min and held for 14 h. The mixed metal oxide is then cooled to room temperature and ground again.

Synthesis of LiNi_{0.33}Mn_{0.33}Co_{0.33}O₂ 270 using Metal Sulfate Compounds and a Low Temperature Heating Step:

A 1 L reaction vessel is assembled that is equipped with a pH probe, temperature probe, a bent adapter that connects a nitrogen line to the vessel, a heating mantle, and an overhead stirring shaft. The reaction vessel is charged with 50 mL of distilled water and is heated to 50° C. under a flow of nitrogen. Nitrogen is added to allow for continuous flushing of the atmosphere. The overhead shaft starts at 300 rpm. All three metal sulfates are added to a first 100 mL media bottle (bottle A); 4.73148 g of nickel (II) sulfate hexahydrate, 3.0424 g of manganese (II) sulfate monohydrate, 5.0598 g of cobalt (II) sulfate heptahydrate and brought up to a final volume of 100 mL with distilled water. The metal sulfates are stirred until they all are dissolved to form a metal compound solution. A second 100 mL media bottle (bottle B) is charged with 6.4 g of NaOH solution and 30 mL of distilled water and mixed until the NaOH has dissolved. To media bottle B was further added 6.8 mL of ammonium hydroxide mixed and taken to a final volume of 50 mL with distilled water, 5 mL of ethylene glycol and mixed well. A third 100 mL media bottle (bottle C) was charged with 2.518 g of lithium hydroxide monohydrate and 30 mL of distilled water and is mixed until all the lithium hydroxide has dissolved. To media bottle C was further added with 6.68 mL of ammonium hydroxide, mixed and taken to a final volume of 50 mL with distilled water. The final media 100 mL bottle (bottle D) is charged with 85 wt % oleic acid, 5% palmitic acid, 4% stearic acid, 5% linoleic acid and 1% linolenic acid and filtered. The addition of all the solutions are such that they are added at different rates, but approximately keep the same molarity of addition. All media solutions are stirred to make sure they are homogeneous through the reaction. The pump rates of the different media are as follows; bottle A=0.21 mL/min, bottle B=0.21 mL/min, bottle C=0.21 mL/min, and bottle D=0.09 mL/min. During this addition time, the pH is monitored and kept at approximately pH=11. If necessary, the pumping rate of the NaOH solution is varied to maintain the desired pH range. After complete addition, the formed precipitate is then filtered and washed three times with distilled water then dried in a 100° C. oven. The dried precipitate is then ground and calcined in the presence of oxygen or air to form the lithium mixed metal oxide LiNi_{0.33}Mn_{0.33}Co_{0.33}O₂. The calcination profile used is as follows: the dried precipitate is heated to 220° C. at a rate of 2° C./min and held for 5 hours, heated to 350° C. at a rate of 2° C./min and held for 5 h, heated to 550° C. at 2° C./min and held for 5 h. The material is then cooled down and ground again. For the final heating profile, the material is then heated to 850° C. at 2° C./min and held for 5 h. The mixed metal oxide is then cooled to room temperature and ground again.

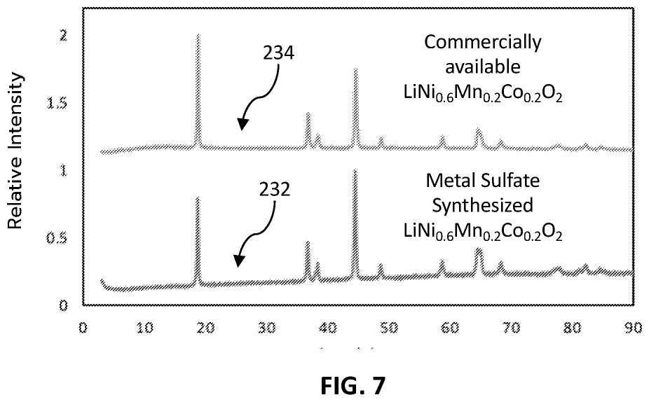

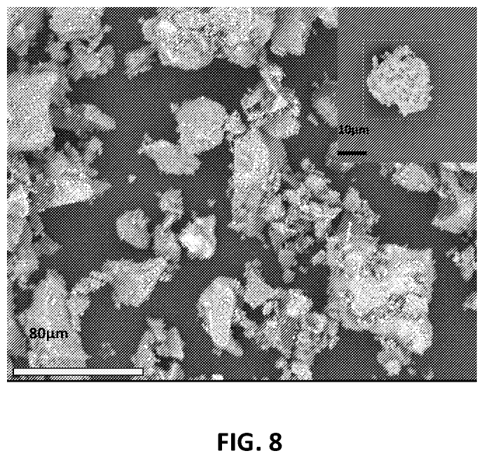

FIG. 7 is the x-ray diffraction pattern 232 for LiNi_{0.6}Mn_{0.2}Co_{0.2}O₂ 230 synthesized from metal sulfate precursors. For comparison purposes, the diffraction pattern 234 for commercially available LiNi_{0.6}Mn_{0.2}Co_{0.2}O₂ is also shown. FIG. 8 is an SEM image of LiNi_{0.6}Mn_{0.2}Co_{0.2}O₂ 230 particles synthesized from metal acetate precursors.

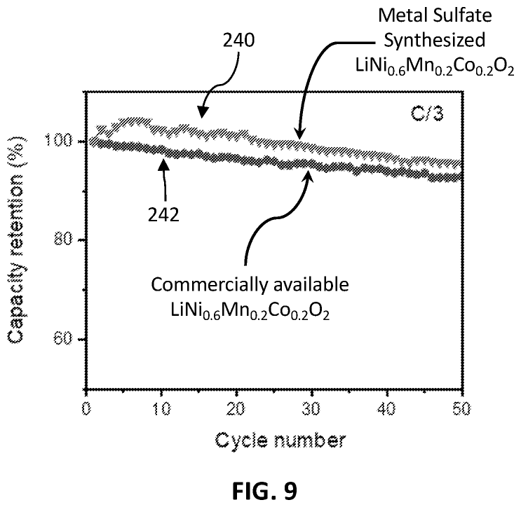

FIG. 9 is cycle life data 240 for LiNi_{0.6}Mn_{0.2}Co_{0.2}O₂ 230 synthesized from metal sulfate precursors. The plot also illustrates the cycle life date 242 for commercially available LiNi_{0.6}Mn_{0.2}Co_{0.2}O₂ for comparison purposes. The discharge rate is C/3 in a half cell.

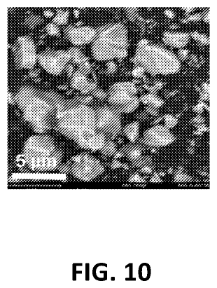

FIG. 10 is an SEM image of LiNi_{0.6}Mn_{0.2}Co_{0.2}O₂ 250 particles synthesized from metal sulfate precursors with a low temperature heating step.

Synthesis of LiNi_{0.6}Mn_{0.2}Co_{0.2}O₂ using a Continuous Process Procedure:

A first vessel is charged with a fatty acid mixture of 85 wt % oleic acid, 5% palmitic acid, 4% stearic acid, 5% linoleic acid and 1% linolenic acid and filtered. The fatty acids are added to the reactor at a pump rate of about 2.4 mL/min. The fatty acids are passed through a 20-μm filter before entering the reactor to remove contaminants of crystalized fatty acids. A second vessel is charged with aqueous 2.0 M lithium hydroxide monohydrate and is pumped into the reactor at a rate of about 4.0 mL/min. A third vessel is charged with an aqueous mixture of 0.9 M 6:2:2 molar ratio of nickel(II) sulfate hexahydrate: manganese(II) sulfate monohydrate: cobalt(II) sulfate heptahydrate and is pumped into the reactor at a rate of about 6 mL/min. A fourth vessel is charged with an aqueous mixture of 2.0 M of sodium hydroxide and is pumped into the reactor at a rate needed to maintain a reaction pH of approximately 11.40 at 50° C. using a pH controller connected to an electrode submerged into the reaction slurry. A fifth vessel is charged with an aqueous mixture of 2.0 M ammonia hydroxide with 10 vol % ethylene glycol and is pumped into the reactor at a rate of about 3.6 mL/min. The reaction vessel is a stainless-steel 4 L Pope Scientific continuously stirred tank reactor (CSTR) in which reactants are pumped into the reactor and the precursor slurry is collected at an overflow outlet continuously during the duration of the reaction. The residence time is approximately 4 h as determined by the sum of rates of the reactant pumps. An additional peristaltic pump is positioned at the outlet to maintain flow. The CSTR is stirred at a rate of 800 rpm by an overhead stirrer. The reaction temperature is maintained at 50° C. Nitrogen gas is flowed into the reactor at a rate of 5 scfh to prevent material oxidation. All reactant solutions are pumped simultaneously into the CSTR for at least 18 h to obtain a steady state of concentration and particle growth before product collection. After 18 h, the precursor slurry is continuously collected for further processing. The precursor is produced at a cathode equivalent of ˜30 g of cathode/hour. After the precursor is collected, the slurry is washed with 3x the volume equivalent of DI water and filtered using a Buchner funnel. The washed precursor is dried for over 48 h in a vacuum oven set to 80° C. The dried precursor is first heated under air in a box furnace to 550° C. at a rate of 2° C./min, held for 2 hours, and cooled to room temperature at a rate of 2° C./min. The annealed precursor is ground with a mortar and pestle and sieved using a 125 μm sieve. The annealed precursor is then added to the box furnace and heated to 850° C. at a rate of 2° C./min, held for 5 hours, and cooled to room temperature at a rate of 2° C./min. The calcined material is ground with a mortar and pestle and re-sieved using a 125 μm sieve. The sieved material is then washed with a 1:1 equivalent of DI water for 5 minutes while stirred and then filtered with two additional equivalents of DI water to remove excess lithium contaminants of lithium hydroxide and lithium carbonate on the surface of the cathode material. The washed cathode is dried in the vacuum oven at 80° C. and re-sieved at 125 μm. The washed material is then re-annealed to 700° C. at a rate of 2° C./min, held for 4 h, and cooled to room temperature at a rate of 2° C./min. The resulting cathode material is sieved to 45 μm.

The invention has been described with reference to various specific and preferred embodiments and techniques. Nevertheless, it is understood that many variations and modifications may be made while remaining within the spirit and scope of the invention.

What is claimed is:

1. A method of producing a particulate lithium metal oxide material comprising the steps of:
providing a metal compound;
adding sufficient water to dissolve the metal compound and form a metal compound solution;
adding a first basic solution, a second basic solution and the metal compound solution to a reaction vessel containing water to form a reaction mixture;
heating the reaction mixture while maintaining a pH of the reaction mixture in a predetermined pH range;
adding a lithium compound;
adding a fatty acid;
filtering a precipitate;
washing and drying the precipitate;
calcining the dried precipitate in an atmosphere containing oxygen to form a calcined lithium metal oxide;
cooling the calcined lithium metal oxide; and
sizing the calcined lithium metal oxide to produce a particulate lithium metal oxide having a predetermined average particle size.

2. The method of claim 1, wherein the first basic solution, second basic solution, and the metal compound solution are added simultaneously to the reaction vessel containing water.

3. The method of claim 1, wherein the basic solutions, the metal compound solution, the lithium compound, and the fatty acids are added simultaneously to the reaction vessel.

4. The method of claim 1, wherein the fatty acids are filtered before being added to the reaction vessel to remove solid contaminants or crystallized fatty acids.

5. The method of claim 1, wherein an optional anti-foaming agent is added to one of the basic solutions prior to addition to the reaction vessel.

6. The method of claim 1, wherein the reaction mixture is agitated to improve mixing of the components of the reaction mixture.

7. The method of claim 1, wherein after filtering the precipitate a filtrate is formed and where the filtrate is recycled and re-used to form additional precipitate.

8. The method of claim 1, wherein the particulate lithium metal oxide is suitable for use in a cathode in a lithium-ion battery.

9. The method of claim 1, further comprising the step of sizing the dried precipitate before calcining.

10. The method of claim 1, wherein heat is continuously applied to the reaction mixture.

11. The method of claim 1, wherein the lithium metal oxide comprises a composition of LiMₓO_{y}.

12. The method of claim 11, wherein M is manganese (Mn), nickel (Ni), or cobalt (Co).

13. The method of claim 11, wherein M is selected from the group consisting of aluminum (Al), titanium (Ti), iron (Fe), vanadium (V), magnesium (Mg), zirconium (Zr), tungsten (W), tantalum (Ta), and boron (B).

14. The method of claim 11, wherein x is 1 or 2 and wherein y is 2 or 4.

15. The method of claim 1, wherein the lithium compound or the metal compound comprises an anionic component that is selected from the group consisting of hydroxide, carbonate, acetate, alkoxide, oxalate, nitrate, nitride, sulfate, and oxide.

16. The method of claim 1, further comprising the step of forming an outer layer on the lithium metal oxide particles.

17. The method of claim 16, wherein the outer layer comprises Li and Co-rich material.

18. The method of claim 17, wherein forming the outer layer of Li and Co-rich material on the comminuted lithium metal oxide cathode comprises the following steps:
tumbling the lithium metal oxide with Li and Co-containing precursor materials to form a coated lithium metal oxide; and
calcining the coated lithium metal oxide to form a lithium metal oxide with a Li and Co-rich layer such that the Co does not substantially enter the structure of the lithium metal oxide portion.

19. The method of claim 1, wherein calcining the dried precipitate comprises the following steps:
first placing the precipitate in a calciner;
then heating the precipitate to 300-400° C. at a ramp rate of up to 15° C./min and holding at 300-400° C. for two to four hours;
then heating the precipitate to 500-600° C. at a ramp rate of up to 15° C./min and holding for two to four hours; and
then heating the precipitate to 700-900° C. at a ramp rate of up to 4° C./min and holding for four to seven hours.

20. The method of claim 19, further comprising an initial low temperature calcining step wherein the dried precipitate is heated to about 150-250° C. at a ramp rate of about 0.1 to about 15° C./min and holding for about 0.5 to 10 hours.

21. The method of claim 1, further comprising adding a dopant to the reaction mixture.

22. The method of claim 21, wherein the dopant replaces a portion of the metal component in the lithium metal oxide.

23. The method of claim 21, wherein the dopant is selected from the group consisting of W, Ti, Mo, Mg, V, Zr, Zn, Nb, Cr, In, Au, B, Fe, Ta, and Ru.

24. The method of claim 1, wherein the particulate lithium metal oxide comprises a coating of an electrically conductive carbon.

25. The method of claim 1, wherein the particulate lithium metal oxide is substantially monocrystalline or polycrystalline.

26. The method of claim 1, wherein the calcined lithium metal oxide has a layered or spinel structure.

27. The method of claim 1, wherein the metal compound is provided from a recycled cathode, recycled metal oxide, or recycled metal hydroxide.

28. The method of claim 1, wherein the first or second basic solution can be the same or different and comprises potassium hydroxide, sodium hydroxide, sodium carbonate, potassium carbonate, ammonium carbonate, or ammonium hydroxide.

29. A method of producing a particulate lithium mixed metal oxide material having a formula of Li(M1)ₓ(M2)₁₋ₓO₂, the method comprising:
providing a first metal compound (M1)A1ₓ and a second metal compound (M2)A2_{y} where x is 1 or 2 and y is 1 or 2;
dissolving the first and second metal compounds in water to form an aqueous metal compound solution;
adding a first basic solution, a second basic solution and the aqueous metal compound solution at predetermined rates to a reaction vessel containing water to form a reaction mixture;
heating the reaction mixture while maintaining a pH of the reaction mixture in a predetermined pH range;
adding a lithium compound;
adding a fatty acid;
filtering a precipitate;
washing and drying the precipitate;
calcining the precipitate in a gas comprising oxygen to yield a calcined lithium mixed metal oxide;
cooling the calcined lithium mixed metal oxide; and
sizing the calcined lithium mixed metal oxide to produce a particulate lithium mixed metal oxide having a predetermined average particle size.

30. The method of claim 29, wherein the first basic solution, second basic solution, and the metal compound solution are added simultaneously to the reaction vessel containing water.

31. The method of claim 29, wherein the basic solutions, the metal compound solution, the lithium compound, and the fatty acids are added simultaneously to the reaction vessel.

32. The method of claim 29, wherein a fluoride-based compound is added to the reaction vessel such that a portion of the oxygen atoms in the oxide layer in the Li(M1)ₓ(M2)₁₋ₓO₂ structure are replaced by fluorine atoms.

33. The method of claim 29, wherein the fatty acids are filtered before being added to the reaction vessel to remove solid contaminants or crystallized fatty acids.

34. The method of claim 29, wherein a de-foaming agent is added to one of the basic solutions prior to addition to the reaction vessel.

35. The method of claim 29, wherein M1 and M2 are different and independently selected from the group consisting of nickel (Ni), cobalt (Co), manganese (Mn), and aluminum (Al).

36. The method of claim 29, wherein M1 and M2 are different and independently selected from the group consisting of titanium (Ti), iron (Fe), vanadium (V), magnesium (Mg), zirconium (Zr), tungsten (W), tantalum (Ta), and boron (B).

37. The method of claim 29, wherein A1 and A2 are anionic components independently selected from the group consisting of hydroxide, carbonate, acetate, alkoxide, phosphate, oxalate, nitrate, nitride, sulfate, and oxide.

38. The method of claim 29, further comprising adding a third metal compound (M3)A3_{z}, where z is 1 or 2 and M3 is a different metal than M1 or M2, to the aqueous metal compound solution to thereby form a lithium mixed metal oxide Li(M1)ₐ(M2)_{b}(M₃)_{c}O₂ wherein a+b+c=1.

39. The method of claim 38, wherein M1, M2 and M3 are independently selected from the group consisting of nickel, cobalt, manganese, and aluminum.

40. The method of claim 38, further combining a fourth metal compound (M4)A4_{zz} wherein zz is 1 or 2 and M4 is a different metal than M1, M2 or M3, to the aqueous metal compound solution to form a lithium mixed metal oxide Li(M1)ₐ(M2)_{b}(M3)_{c}(M4)_{d}O₂ wherein a+b+c+d=1.

41. The method of claim 40, wherein M1, M2, M3, and M4 are independently selected from the group consisting of nickel, cobalt, manganese, and aluminum.

42. The method of claim 40, wherein M1, M2, M3, and M4 are independently selected from the group consisting of titanium (Ti), iron (Fe), vanadium (V), magnesium (Mg), zirconium (Zr), tungsten (W), tantalum (Ta), and boron (B).

43. The method of claim 29, wherein the first basic solution is added to the reaction vessel at a first rate R, the second basic solution is added at a rate of 0.1-0.3 ×R, and the aqueous metal compound solution is added at a rate of 0.2-1.2 ×R.

44. The method of claim 43, wherein the first basic solution is added at the first rate R over a period of 15-25 hours.

45. The method of claim 29, wherein the lithium compound is added at a molar ratio of 1-2 x the combined moles of transition metals in the metal compounds.

46. The method of claim 29, wherein the fatty acid is added at a rate of 2-6 x R.

47. The method of claim 29, wherein the fatty acid is added at a molar ratio of 0.1-1 x moles of lithium.

48. The method of claim 29, wherein after filtering the precipitate a filtrate is formed and where the filtrate is recycled and re-used to form additional precipitate.

49. The method of claim 29, further comprising the step of sizing the dried precipitate before calcining.

50. The method of claim 29, wherein calcining the dried precipitate forms a polycrystalline or monocrystalline lithium mixed metal oxide and comprises the following steps:
first placing the precipitate in a calciner;
then heating the precipitate to 300-400° C. at a ramp rate of up to 15° C./min and holding at 300-400° C. for two to four hours;
then heating the precipitate to 500-600° C. at a ramp rate of up to 15° C./min and holding for two to six hours; and
then heating the precipitate to 700-1000° C. at a ramp rate of up to 4° C./min and holding for four to fifteen hours.

51. The method of claim 50, further comprising an initial low temperature calcining step wherein the dried precipitate is heated to about 150-250° C. at a ramp rate of about 0.1 to about 15° C./min and holding for about 0.5 to 10 hours.

52. A method of producing a particulate lithium metal phosphate material comprising the steps of:
providing a metal compound;
adding sufficient water to dissolve the metal compound and form a metal compound solution;
adding a first basic solution and a second basic solution wherein the first or second basic solution comprises a phosphate containing compound to the metal compound solution simultaneously at predetermined rates in a reaction vessel containing heated water to form a reaction mixture;
heating the reaction mixture while maintaining a pH of the reaction mixture in a predetermined pH range;
adding a lithium compound;
adding a fatty acid;
filtering a precipitate;
washing and drying the precipitate;
calcining the dried precipitate in an inert atmosphere to form a calcined lithium metal phosphate;
cooling the calcined lithium metal phosphate; and
sizing the calcined lithium metal phosphate to produce a particulate lithium metal phosphate having a predetermined particle size.

53. The method of claim 52, wherein the first or second basic solution comprises (NH₄)₃PO₄, Na₃PO₄, Li₃PO₄, K₃PO₄, H(NH₄)₂PO₄, or H₂(NH₄)PO₄.

54. The method of claim 52, wherein the metal is iron (II), nickel (II), manganese (II), cobalt (II), or a combination thereof.

55. The method of claim 52, wherein the lithium compound comprises Li₃PO₄, Li₂HPO₄, or LiH₂PO₄.
